(19) United States
(12) Patent Application Publication
(10) Pub. No.: US 2023/0070331 A1
(43) Pub. Date: Mar. 9, 2023

(54) METHOD FOR A SEAT BELT SYSTEM, SEAT BELT SYSTEM FOR A VEHICLE AND VEHICLE COMPRISING A SEAT BELT SYSTEM

(71) Applicant: ZF AUTOMOTIVE GERMANY GMBH, Alfdorf (DE)

(72) Inventors: Oliver GROSS, Schwäbisch Gmünd (DE); Karl HUDELMAIER, Alfdorf (DE); Karl BIRK, Ebersbach (DE); Marcel KÖNIG, Berglen (DE)

(21) Appl. No.: 17/789,692

(22) PCT Filed: Dec. 17, 2020
(86) PCT No.: PCT/EP2020/086619

§ 371 Date: Nov. 16, 2022

(30) Foreign Application Priority Data
Dec. 31, 2019 (DE) 10 2019 135 914.7

(51) Int. Cl. B60R 22/48; B60R 21/015

(52) U.S. Cl. CPC B60R 22/48; B60R 21/01546; B60R 2022/4816; B60Q 3/242

(57) ABSTRACT

A method for a seat belt system (10) in a vehicle (14), the seat belt system (10) comprising a control unit (36) and at least one extendable seat belt (18) with a locking tongue (22), at least one belt buckle (24) and at least one webbing extension measuring device (30), includes the steps of:
a) determining the webbing extension by means of the webbing extension measuring device (30),
b) determining whether a buckling operation has occurred,
c) activating at least one guide element on the belt buckle (24) and/or the seat belt (18), if a buckling operation has occurred.

Moreover, the invention provides a seat belt system (10) for a vehicle (14) comprising an extendable seat belt (18) as well as a vehicle comprising a seat belt system (10).

### TECHNICAL FIELD

The invention relates to a method for a seat belt system in a vehicle, the seat belt system comprising an extendable seat belt. The invention further relates to a seat belt system for a vehicle and to a vehicle comprising such seat belt system.

### BACKGROUND

Seat belt systems for vehicles are basically known. They have the function of restraining a vehicle occupant belted by the seat belt in the event of large forces acting on the vehicle occupant, for example during emergency braking or crash, in the seat and, thus, increasing the safety. Optimum protection can only be ensured, however, if the seat belt is correctly buckled by the vehicle occupant.

It is known from prior art to equip belt buckles with a lighting element so that the latter can be found more easily by the vehicle occupant in the dark, for example, and the buckling operation can be facilitated. Nevertheless, it is possible that, during the buckling operation, the vehicle occupant inserts the locking tongue of the seat belt into a belt buckle of the adjacent seat rather than into the associated belt buckle.

### SUMMARY

It is therefore an object of the invention to provide a method by which the buckling operation can be facilitated and optimized for the vehicle occupant. It is another object of the invention to provide a seat belt system which is configured to carry out such method to ensure an improved protective effect.

For achieving the object, a method for a seat belt system in a vehicle is provided, the seat belt system comprising a control unit and at least one extendable seat belt with a locking tongue, at least one belt buckle and at least one webbing extension measuring device. The method includes the following steps of:
a) detecting a webbing extension by means of the webbing extension measuring device,
b) detecting whether a buckling operation has occurred,
c) activating at least one guide element at the belt buckle and/or the seat belt, if a buckling operation has occurred.

The method according to the invention provides the vehicle occupant during the buckling operation with an auxiliary means which facilitates a correct connection of the locking tongue of the seat belt with the associated belt buckle by the vehicle occupant. In this way, the locking tongue can be prevented from being inserted into a belt buckle of the adjacent seat rather than into the associated belt buckle, thus allowing the seat belt system to provide a preferably optimum protective effect for the vehicle occupant in a case of restraint.

In one embodiment, for determining whether a buckling operation has occurred, it is initially checked by the control unit when determining a webbing extension, whether the locking tongue of the seat belt is already engaged in the associated belt buckle. Unless this is the case, the control unit determines whether the webbing extension determined by the webbing measuring device is so significant that a buckling operation by a vehicle occupant can be concluded therefrom. The significant webbing extension corresponds in particular to a webbing extension length stored in the control unit from which one can conclude that the vehicle occupant buckles up or intends to buckle up.

In another typical embodiment, it can only be determined for determining the buckling operation whether such a significant webbing extension has occurred.

In another alternative embodiment, it can moreover be identified, for determining the buckling operation, via the webbing extension measuring device and/or further sensor elements if at the beginning of the determined webbing extension a storage position of the seat belt has existed in which the seat belt is provided when it is not in use. In the storage position, the webbing of the seat belt is usually completely wound onto the belt reel. In addition, it can be determined via further sensor elements, such as a pressure sensor in the seat surface of the vehicle seat, whether a vehicle occupant has taken a seat in the vehicle seat.

In a preferred embodiment, the guide element at the belt buckle and/or the seat belt is deactivated as soon as the locking tongue engages in the belt buckle and the buckling operation is completed.

The guide element preferably comprises an output device for generating a visual and/or an acoustic and/or a haptic signal. In a preferred embodiment, the output device of the guide element is an illuminant or comprises an illuminant. Preferably, the illuminant is suited to output light of different colors.

By presenting different colors, the vehicle occupant can be enabled to get feedback via the output device of the guide element as soon as the locking tongue is inserted into and engaged with the associated belt buckle.

Alternatively, or additionally, the output device of the belt buckle may also be provided to output initially during the buckling operation a flashing light signal and to output a permanently illuminated light signal as soon as the locking tongue engages with the belt buckle.

Further, it is thus possible to indicate a locking tongue inserted into the wrong belt buckle to the vehicle occupant by a suitable light signal, such as by red flashing.

As a matter of course, the afore-described signals can be transmitted to the vehicle occupant also acoustically and/or haptically, for example by an alert and/or vibration of the belt buckle.

In a typical embodiment, the seat belt system comprises plural extendable seat belts with locking tongues, plural belt buckles and plural webbing extension measuring devices. In particular an extendable seat belt with a locking tongue, a belt buckle and a webbing extension measuring device is associated with each vehicle seat. The method according to the invention can be particularly carried out simultaneously for the respective seat belts. Thus, the method according to the invention helps assist plural vehicle occupants at the same time in fastening their seat belts when buckling up. In particular, a warning signal is provided to be output via the output device of the guide element and/or a further output device, if the locking tongue of a seat belt is not inserted into the belt buckle associated with the seat belt. As a further output device in particular an output device already existing in the vehicle can be utilized, such as a display of the instrument panel, the combination instrument and/or the loudspeakers of the vehicle.

In one embodiment, both the seat belt and the belt buckle may include a guide element. This allows in particular, if the seat belt system comprises plural extendable seat belts, that, for example, by outputting a same-color light signal at the seat belt and the belt buckle of a respective vehicle seat it is indicated to the vehicle occupant in the respective vehicle seat into which belt buckle the locking tongue must be inserted. That is, that for example the guide elements of the seat belt and the belt buckle of the first vehicle seat are outputting a green-color light signal and the guide elements of the seat belt and the belt buckle of the second vehicle seat (e.g., the adjacent seat) are outputting a red-color light signal. Accordingly, the control unit controls the color which the light signal shows.

The seat belt, in particular the locking tongue, and the belt buckle may be further provided to comprise further sensor elements which allow the control unit to determine, via the measured values/data of the sensor elements, an approach of the locking tongue to the associated belt buckle. For example, in such embodiment it may be provided that during approach the intensity of the signal made available to the vehicle occupant by the guide element is varied. For example, the light intensity can be increased or minimized and/or a flashing frequency of a light signal can be increased or reduced.

The control unit of the vehicle occupant safety system may be a control unit separate from a vehicle control unit of the vehicle or, alternatively, may be integrated in the vehicle control unit, in particular the onboard computer of the vehicle. If the control unit is configured separately from the vehicle control unit, the control unit is preferably configured so that it can communicate and exchange data with the vehicle control unit. The control unit is connected at least to the webbing extension measuring device and the guide element of the seat belt system for signal transmission. Preferably, the control unit is moreover connected to further sensor elements of the seat belt system and/or further output devices of the vehicle.

The webbing extension can be measured by the webbing extension measuring device in a relative measuring process. Relative in this context means that only the length and preferably the rate of the webbing extension during a webbing movement is measured or, resp., determined, but it is not known, for example, how far the webbing is exactly extended based on a storage position in which the seat belt is not in use. A relative measuring of the webbing extension is sufficient, because this can determine the displacement of the vehicle occupant caused by the respective driving operation in a sufficiently exact way.

As an alternative, the webbing extension can be measured also absolutely or quasi absolutely by the webbing extension measuring device. Absolutely in this context means that each revolution of the belt reel and, resp., each webbing portion which is extended is detected, so that it is always known exactly how far the webbing is extended. Quasi absolutely means that the webbing extension measuring device is always active, that is, it “does not sleep” and, resp., has no standby mode in which no measuring takes place. In this way, webbing can be prevented from being extended or wound up without being detected by the seat belt system. Thus, the actual webbing extension is known at any time and/or is reliably determinable. This is especially advantageous, if by the determined webbing extension in further processes further conditions are to be checked, such as whether a vehicle occupant is properly buckled up (so-called misuse detection) and/or whether the vehicle occupant is sitting in an improper seating position in the vehicle seat (so-called out-of-position detection).

The sensor and/or a measuring scale of the webbing measuring device are preferably disposed or arranged on the webbing or in the belt retractor on the spindle, the gearwheel or the control disk.

In accordance with the invention, for achieving the above-mentioned object also a seat belt system for a vehicle comprising an extendable seat belt with a locking tongue, a belt buckle, a webbing extension measuring device and a control unit which is adapted to carry out the method according to the invention is provided. The seat belt system offers the corresponding advantages of the afore-mentioned method.

In a preferred embodiment, the seat belt system includes plural extendable seat belts with locking tongues, plural belt buckles and plural webbing extension measuring devices. Preferably, an extendable seat belt with a locking tongue, a belt buckle and a webbing extension measuring device are associated to each vehicle seat. Moreover, according to the invention, for achieving the above-mentioned object a vehicle comprising a seat belt system according to the invention offering the above-listed advantages is provided.

### BRIEF DESCRIPTION OF THE DRAWINGS

Further advantages and features will be evident from the following description and the attached drawings, wherein:

FIG. 1 shows a schematic view of a vehicle according to the invention comprising a seat belt system according to the invention, and

FIG. 2 shows a schematic view of an embodiment of a belt buckle including a guide element.

### DESCRIPTION

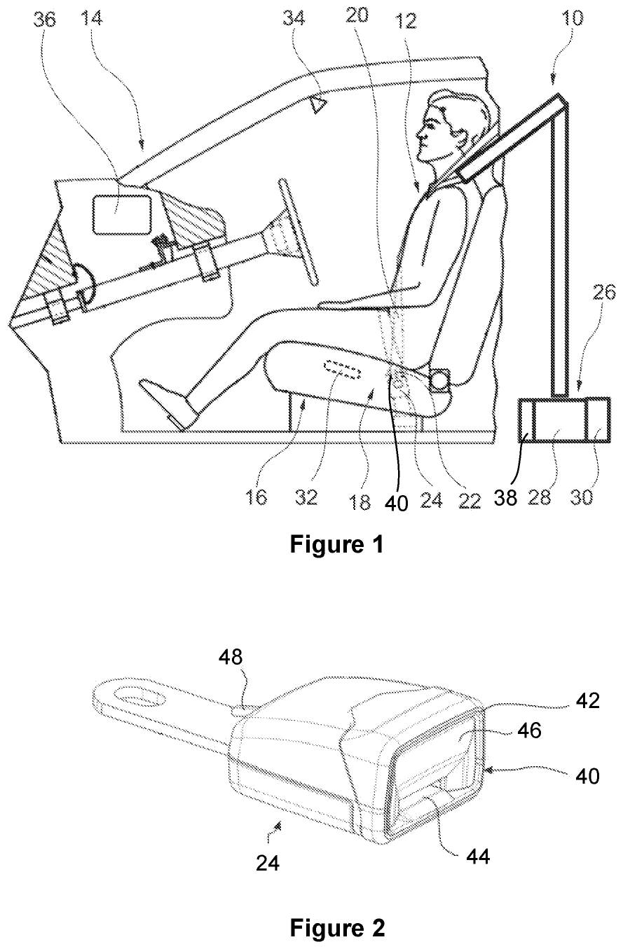

FIG. 1 illustrates a seat belt system 10 for a vehicle occupant 12 in a vehicle 14 which is a passenger car in this case. The vehicle occupant 12 is sitting in a vehicle seat 16 of the vehicle 14. The vehicle 14 has a drive for accelerating the vehicle 14 and a braking device for decelerating the vehicle 14.

In an alternative embodiment, the seat belt system 10 may be provided for any seats in a vehicle 14 to protect the respective vehicle occupant 12 in a case of restraint, such as a crash.

In particular, the seat belt system 10 is suited for use in any vehicles, specifically autonomously driving vehicles.

The seat belt system 10 comprises a seat belt 18 with a webbing 20 and a locking tongue 22 as well as a belt buckle 24 which the locking tongue 22 can engage with. The webbing 20 serves to restrain the vehicle occupant 12 in the vehicle seat 16, when the belt buckle 24 is locked. The belt buckle 24 is locked by the locking tongue 22 being inserted into the belt buckle 24 and engaging in the latter. The belt buckle and/or the seat belt 18, in this case the locking tongue 22, comprise a guide element 40 including an output device in the form of an illuminant 42 in the shown example. Alternatively, or additionally to such optical output device, the guide element 40 may comprise an output device for generating an acoustic and/or haptic signal (not shown).

Further, the seat belt system 10 comprises a belt retractor 26 with a belt reel 28 onto which the webbing 20 is partly wound and which exerts tensile force upon the webbing 20. The webbing 20 and, thus, the seat belt 18 are extendably accommodated in the vehicle 14 in this way. The shown seat belt system 10 further comprises a belt tensioner 38 which is operatively connected to the belt reel 28.

In an alternative embodiment, the webbing 20 may be provided to be extendable in any way.

The belt reel 28 includes a webbing extension measuring device 30, for example in the form of a reel rotation sensor by which the rotation of the belt reel 28 and, thus, the length of the currently extended webbing 20, the so-called webbing extension, is absolutely detected. In other words, the webbing extension is the length of the part of the webbing 20 that is wound off the belt reel 28. Such measuring in which the exact webbing extension is known is usually made by absolute measuring. An absolute measuring offers the particular advantage that a storage position of the webbing 20 can be determined in which the webbing 20 is completely wound onto the belt reel 28.

As an alternative, the webbing extension can be determined in particular also by a relative measuring, where the length of the part of the webbing 20 which has already been wound off the belt reel 28 is not measured, but the reference point is preferably given by the respective webbing extension at the beginning of measuring. This offers the advantage that for a relative measuring a simpler webbing extension measuring device can be used. In particular, the current webbing extension can be determined in any way, preferably in a relative but also in an absolute or quasi absolute manner.

Basically, the webbing extension measuring device 30 may be any device which is adapted to determine the webbing extension. For example, the webbing extension measuring device 30 may comprise indirect or direct measuring sensors which measure the webbing extension for example by direct scanning (such as via a friction wheel) and/or indirect scanning (such as via a laser scanner that scans a measuring scale integrated on and/or in the webbing).

The shown vehicle 14 further comprises another output device 34 in the form of a display element that is suited for transmitting information to the vehicle occupant 12, for example in an acoustic, visual and/or haptic manner. The vehicle occupant 12 can be informed via the output device, for example, about having failed to fasten his/her seat belt 18. It may be particularly provided that a warning signal is output by the further output device 34, if the vehicle occupant 12 is not properly buckled, for example as the locking tongue 22 of the seat belt 18 is not inserted into the belt buckle 28 associated with the seat belt 18. As a matter of course, the further output device 34 may be disposed at any place in the vehicle 14 suitable for transmitting the information to the vehicle occupant 12. In particular, the further output device 34 can be provided by output devices already existing in the vehicle 14, such as loudspeakers, or can be integrated in the same, such as in an instrument panel of the vehicle 14.

The webbing extension measuring device 30, the pressure sensor 32, the further output device 34 and the guide element 40 are connected to a control unit 36 of the seat belt system 10 for signal transmission.

The control unit 36 in the present case is integrated in the vehicle control unit of the vehicle 14, in this case the onboard computer of the vehicle 14. In an alternative embodiment, the control unit 36 of the seat belt system 10 can be provided separately, being preferably connected to the onboard computer of the vehicle 14 for signal transmission.

FIG. 2 illustrates an embodiment of the belt buckle 24. The belt buckle 24 includes a locking tongue receptacle 44 for receiving the locking tongue 22 of the seat belt 18 as well as a press switch 46 which is used to release the click-stop connection between the locking tongue 22 and the belt buckle 24.

Moreover, the belt buckle 24 comprises a guide element 40. The guide element 40 has an output device which is configured as an illuminant 42 here. In addition, a connector 48 via which the belt buckle 24, specifically the guide element 40, can be connected to the control unit 36 for signal transmission and/or the illuminant 42 can be supplied with energy is schematically represented.

The control unit 36 is adapted to control the afore-mentioned systems and to carry out the following method for operating the seat belt system 10.

In particular upon starting the vehicle, it is determined by the control unit via the webbing extension measuring device 30 whether a webbing extension has occurred.

If a webbing extension of the webbing 20 of the seat belt 18 is identified, the control unit 36 determines whether a buckling operation has occurred in which the vehicle occupant 12 fastens the seat belt 18. For this purpose, the control unit 36 determines whether the webbing extension is so significant that a buckling operation by the vehicle occupant 12 can be concluded therefrom. The significant webbing extension corresponds to a webbing extension length stored in the control unit from which one can conclude, based on empirical values, that the vehicle occupant buckles up or intends to buckle up.

In addition, for determining whether a buckling operation has occurred, it can be checked by the control unit 36 via a belt buckle switch not shown here whether the locking tongue 22 of the seat belt 18 is already engaged in the associated belt buckle 24.

Furthermore, when determining whether a buckling operation has occurred, it can be identified by the control unit 36 via the webbing extension measuring device 30 and/or further sensor elements (not shown) whether, at the beginning of the determined webbing extension, there has existed a storage position of the seat belt 18 in which the seat belt 18 is provided, unless it is used by a vehicle occupant 12. In the storage position, the webbing 20 of the seat belt 18 is usually wound completely onto the belt reel 28.

In addition, when determining whether a buckling operation has occurred, the control unit 36 can determine via further sensor elements, such as the pressure sensor 32 in the seat surface of the vehicle seat 16, whether a vehicle occupant 12 has taken a seat in the vehicle seat 16.

If the control unit 36 determines a buckling operation, the control unit 36 activates the guide element 40 at the belt buckle 24. In an embodiment in which the seat belt 18 also comprises a guide element 40, the latter is equally activated.

In order to indicate the belt buckle 24 associated with the seat belt 18 to the vehicle occupant 12, the guide element in the shown embodiment comprises an output device configured as illuminant 42 which is activated for this purpose so that a light signal is emitted.

The illuminant 42 is preferably suited to show light signals in different colors. This enables, for example, the light signal generated by the illuminant 42 of the guide element 40 to change its color as soon as the locking tongue 22 is engaged in the associated belt buckle 24. After the guide element 40 has indicated to the vehicle occupant 12 that the locking tongue 22 is engaged with the associated belt buckle 24, the guide element 40 can be deactivated.

As an alternative, such a change of color of the light signal of the illuminant 42 can be utilized to indicate to the vehicle occupants 12 that the locking tongue 22 is not engaged in the associated belt buckle 24.

If the seat belt system 10 comprises plural seat belts 18, wherein an extendable seat belt 18 with a locking tongue 22 and a belt buckle 24 is associated with each vehicle seat 16, the control unit 36 can further be provided to have the respective guide elements 40 of the seat belt 18 and of the belt buckle 24 generate a light signal of the same color so that each vehicle occupant 12 can be shown which belt buckle 24 is the belt buckle 24 associated with his/her vehicle seat 16.

In an alternative embodiment, the guide element 40 can be deactivated immediately after it was identified by the control unit 36 that the locking tongue 22 is engaged with the associated belt buckle 24.

In addition, the guide element 40 can be provided to be deactivated by the control unit 36, if it is identified that the seat belt 18 is in the storage position again.

The seat belt system 10 is not limited to one single seat belt 18 which is monitored, but it may comprise plural seat belts 18.

The invention is not limited to the shown embodiment. In particular, individual features of one embodiment may be combined with any features of other embodiments, in particular independently of the other features of the corresponding embodiments.

1-10. (canceled)

11. A method for a seat belt system (10) in a vehicle (14), the seat belt system (10) comprising a control unit (36) and at least one extendable seat belt (18) with a locking tongue (22), at least one belt buckle (24) and at least one a webbing extension measuring device (30), including the steps of:
a) determining a webbing extension by means of the webbing extension measuring device (30),
b) determining whether a buckling operation has occurred,
c) activating at least one guide element (40) on the belt buckle (24) and/or the seat belt (18), if a buckling operation has occurred.

12. The method for a seat belt system (10) according to claim 11, wherein the guide element (40) on the belt buckle (24) and/or the seat belt (18) is deactivated as soon as the locking tongue (22) engages in the belt buckle (24) and the buckling operation is completed.

13. The method according to claim 11, wherein the guide element (40) comprises an output device for generating a visual and/or an acoustic and/or a haptic signal.

14. The method according to claim 11, wherein the seat belt system comprises plural extendable seat belts (18) with locking tongues (22), plural belt buckles (24) and plural webbing extension measuring devices (30), in particular wherein an extendable seat belt (18) with a locking tongue (22), a belt buckle (24) and a webbing extension measuring device (30) are associated with each vehicle seat (16).

15. The method according to claim 11, wherein a warning signal is output via the output device of the guide element (40) and/or another output device (34), if the locking tongue (22) of the seat belt (18) is not inserted into the belt buckle (28) associated with the seat belt (18).

16. The method according to claim 11, wherein the output device of the guide element (40) is in the form of an illuminant (42), in particular wherein the illuminant (42) is suitable for displaying different colors.

17. The method according to claim 11, wherein the webbing extension is measured relatively or absolutely or quasi absolutely.

18. A seat belt system (10) for a vehicle (14), comprising an extendable seat belt (18) with a locking tongue (22), a belt buckle (24), a webbing extension measuring device (30) and a control unit (36) which is adapted to carry out the method according to claim 11.

19. The seat belt system according to claim 18, comprising plural extendable seat belts (18) with locking tongues (22), plural belt buckles (24) and plural webbing extension measuring devices (30), in particular wherein an extendable seat belt (18) with a locking tongue (22), a belt buckle (24) and a webbing extension measuring device (30) are associated with each vehicle seat (16).

20. A vehicle (14) comprising a seat belt system (10) according to claim 18.
